(19) United States
(12) Patent Application Publication
(10) Pub. No.: US 2016/0162897 A1
(43) Pub. Date: Jun. 9, 2016

(54) System and method for user authentication using crypto-currency transactions as access tokens

(71) Applicant: The Filing Cabinet, LLC, Stamford, CT (US)

(72) Inventor: Patrick Joseph Feeney, Stamford, CT (US)

(21) Appl. No.: 14/958,427

(22) Filed: Dec. 3, 2015

Related U.S. Application Data
(60) Provisional application No. 62/086,843, filed on Dec. 3, 2014.

(51) Int. Cl. G06Q 20/40; G06Q 20/38; G06Q 20/06

(52) U.S. Cl. CPC G06Q 20/4014; G06Q 20/065; G06Q 20/3829

(57) ABSTRACT

A method for crypto-currency transaction authentication includes receiving, by a computing device, from a data storage device associated with a first entity, an authentication information demonstrating possession of a private key, retrieving, by the computing device, from an audit chain, at least one crypto-currency transaction to an address associated with a public key corresponding to the private key, and authenticating, by the computing device, based on the retrieved crypto-currency transaction, the first entity.

### TECHNICAL FIELD

This invention relates to authentication. More particularly, the present invention relates to methods and apparatus for immutable identification authentication using public key cryptography and audit chains.

### BACKGROUND ART

A fundamental issue in Internet commerce and communication is authentication, as well as privacy protections and authentic and accurate immutable trace and track systems for inventory. One party to an exchange of information or funds must be able to trust the other party sufficiently to complete the exchange. For traditional exchanges, such as in-person exchanges, the first party would identify the second party, and rely on that identity to ensure trust. Establishing a level of trust might be accomplished by assessing the second party's reputation in a community or with a government or financial institutions, whether by word-of-mouth, criminal background checks, or credit checks. Alternatively, the act of identification itself might be sufficient to make the second party behave in a more trustworthy manner, to protect the second party to harm the second party might incur to itself or its reputation as a result of bad behavior. Online actors have duplicated this by requiring parties to identify themselves, but the inherent anonymity of communication via computer networks makes it more difficult to prove identity. Among the solutions presented to this problem is the use of digital signatures, which demonstrate the possession by the signing party of secret cryptographic information, tied to the signing party by the intercession of a trusted third party, known as a certificate authority. This system, while effective, can be expensive and inflexible. Certificate authorities expect compensation for their efforts, and impose requirements for identification that some entities may find burdensome. Centralization of an authentication system is disadvantageous to the user. It is also flawed, because it exposes control of many items, and rolls those many items up into one entity, storing it in a central area, creating undue risk. One well-known risk presented by such single points of failure is the theft of information by hackers, which has led to the theft of credit card numbers from several large retail outlets in recent months. The reason the hackers were able to get hundreds of thousands of users' information in a single attack was because the credit card information was stored by the retailers in a centralized fashion.

In view of the above, there is a need for a more versatile technique for online authentication.

### SUMMARY OF THE EMBODIMENTS

In one aspect, a method for crypto-currency transaction authentication includes receiving, by a computing device, from a data storage device associated with a first entity, authentication information demonstrating possession of a private key. The method includes retrieving, by the computing device, from an audit chain, at least one crypto-currency transaction to an address associated with a public key corresponding to the private key. The method includes authenticating, by the computing device, based on the retrieved crypto-currency transaction, the first entity.

In a related embodiment, receiving further includes receiving the public key. In another embodiment, receiving further involves receiving a digital signature signed with the private key. In an additional embodiment, receiving also includes transmitting, by the computing device, a challenge datum to the data storage device, and receiving a digital signature signing the challenge datum from the data storage device. In another embodiment, receiving additionally involves transmitting, by the computing device, to the data storage device, a message encrypted using the public key, and receiving, by the computing device, from the data storage device, a decrypted version of the message. In yet another embodiment, retrieving further includes retrieving a transaction from a second entity to the first entity.

In another related embodiment, authenticating further involves authenticating the second entity and determining that the at least one crypto-currency transaction represents an act of authentication of the first entity by the second entity. In another embodiment, the transaction from the first second entity to the first entity further includes a transaction granting access rights to the first entity. In yet another embodiment, authenticating further includes determining a reputation based on the at least one crypto-currency transaction. In another embodiment still, authenticating also involves determining the commercial nature of the at least one crypto-currency transaction. In an additional embodiment, authenticating also includes determining a financial value of the at least one crypto-currency transaction. In another embodiment, authenticating also involves determining an identity of the first entity.

In a further embodiment authenticating also involves determining at least one access right of the first entity. In a related embodiment, determining the at least one access right further includes determining that the second entity possesses at least one access right and determining that the at least one crypto-currency transaction represents a transfer of the at least one access right possessed by the second entity to the first entity. In still another embodiment, determining the at least one access right further includes identifying the first entity and retrieving an access right previously associated with the first entity. In an additional embodiment, the audit chain includes a secured audit chain. In another embodiment, the audit chain includes a cryptographically secured audit chain. In yet another embodiment, the audit chain includes a block chain. Another embodiment includes filing, by the computing device, the at least one crypto-currency transaction.

In another aspect, a system for crypto-currency transaction authentication includes a data storage device associated with a first entity. The system includes a computing device configured to receive, from the data storage device, authentication information demonstrating possession of a private key, to retrieve, from an audit chain, at least one crypto-currency transaction to an address associated with a public key corresponding to the private key, and to authenticate, based on the retrieved crypto-currency transaction, the first entity.

These and other features of the present invention will be presented in more detail in the following detailed description of the invention and the associated figures.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of an computing device as described herein;

FIG. 1B is a schematic diagram of a network-based platform, as disclosed herein;

FIG. 2 is a block diagram of an embodiment of the disclosed system; and

FIG. 3 is a flow diagram illustrating one embodiment of the disclosed method.

### DETAILED DESCRIPTION OF SPECIFIC EMBODIMENTS

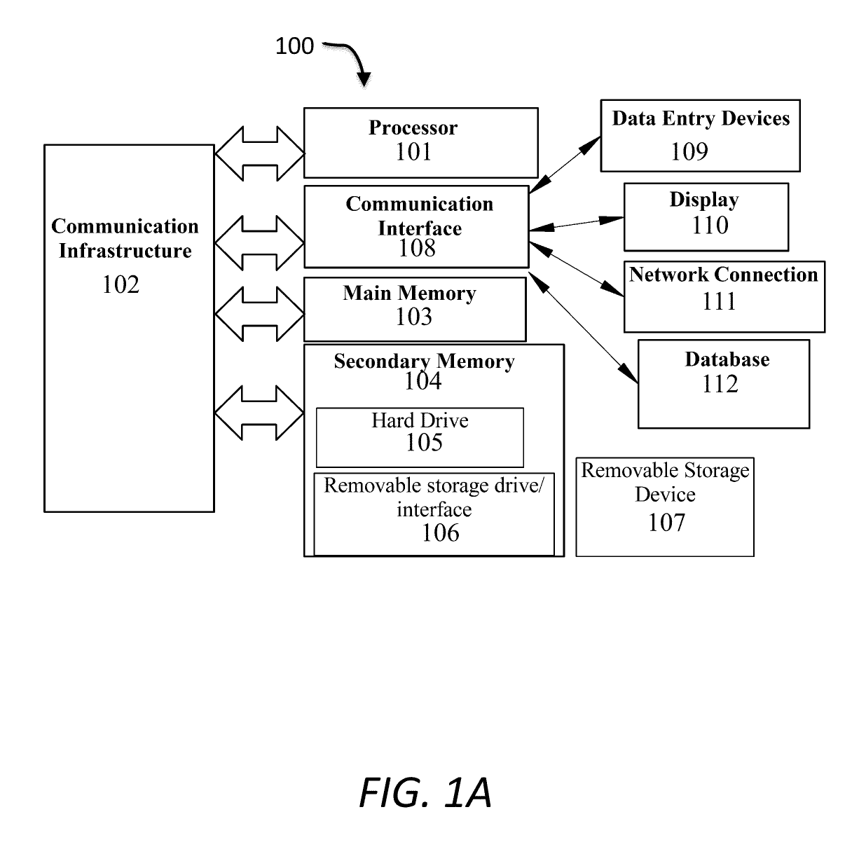

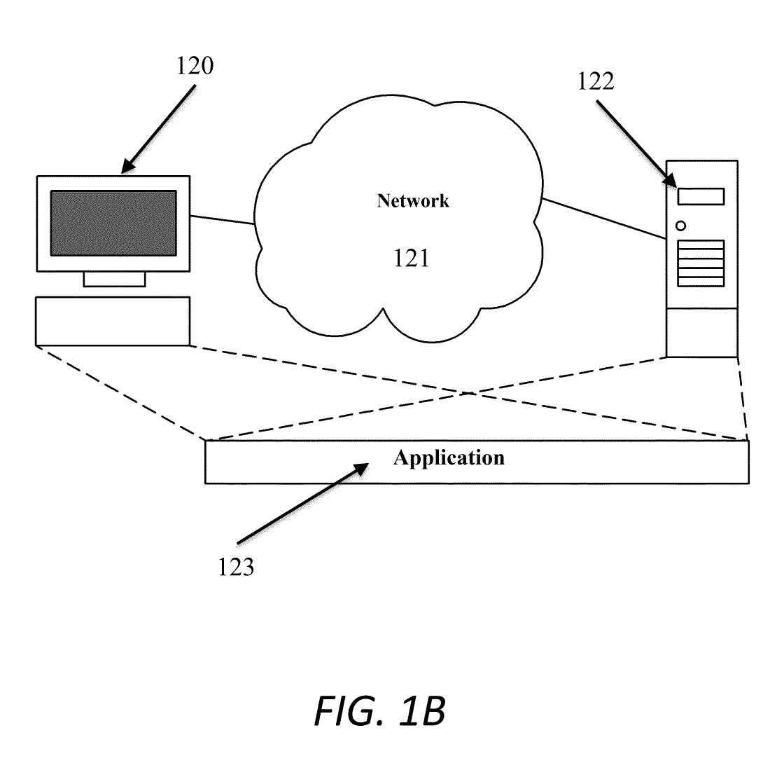

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. A code scanner coupled to a computing device is a device that can extract information from a “code” attached to an object. In one embodiment, a code is an object or pattern that contains data concerning the object to which it is attached that may be extracted automatically by a scanner; for instance, a code may be a bar code whose data may be extracted using a laser scanner. A code may include a quick-read (QR) code whose data may be extracted by a digital scanner or camera. A code may include a radio frequency identification (RFID) tag; the code may include an active RFID tag. The code may include a passive RFID tag. The code may be a portable memory device such as a smartcard; the code may be a contact smartcard or a contactless smartcard. The code may contain some processing circuitry; for instance, the code may contain a crypto-processor. The code may implement the Europay, Mastercard, Visa (“EMV”) standard, or a similar standard. A computing device 100 may also be coupled to a code exporter; in an embodiment, a code exporter is a device that can put data into a code. For instance, where the code is a two-dimensional image printed on paper or another object, the code exporter may be a printer. Where the code is a non-writable RFID tag, the code exporter may be a device that can produce a non-writable RFID tag. Where the code is a writable RFID tag, the code exporter may be an RFID writer; the code exporter may also be a code scanner, in some embodiments.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. The network 121 can be divided into sub-networks as well, such as a network in which the computing devices making up the server 122 are nodes, or a network in which the nodes are computing devices participating in particular coordinated actions. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud. Some web applications treat the network 121 or a part thereof as a “peer-to-peer” network, which distributes computing tasks and resources among its nodes; where each computing device making up a node of the network 121 can act as a client 120 or a server 122 depending on the task the protocols of the peer-to-peer network direct it to perform.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause a computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. The digital signature may be incorporated in a digital certificate, which is a document authenticating the entity possessing the private key by authority of the issuing certificate authority, and signed with a digital signature created with that private key and a mathematical representation of the remainder of the certificate. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed system and methods use the power of decentralized computing and public key cryptology to create a flexible, powerful authentication and access control system. The use of signed transactions in reviewable audit chains to store and convey authentication information enables straightforward anti-phishing techniques, theft and hacker prevention, and fine-tuned access control. As the methods and systems described herein can obviate the need for central security authorities, they can eliminate the danger of central authority exposure. Embodiments, may be used to strengthen security features, stops distributed denial-of-service attacks, and stop “man in middle attacks.” Some embodiments can protect computers, mobile phones and tablets from hacking; other embodiments immutably identify such devices with their owners.

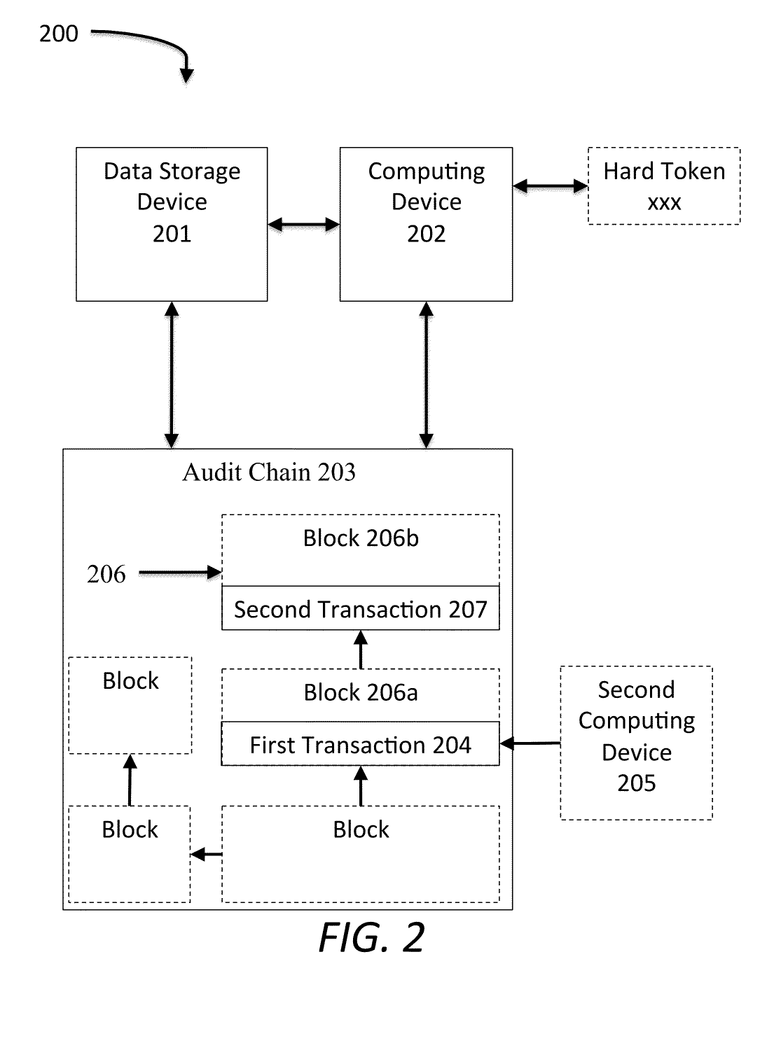

FIG. 2 illustrates an embodiment of a system 200 for user authentication using crypto-currency transactions. As an overview, the system 200 includes a data storage device 201. The system 200 includes a computing device 202. The system 200 includes an audit chain 203.

Some embodiments of the system and method involve setting and enforcing access rights. In an embodiment, an access right is the right of an entity to use a computing device or network of computing devices for at least one purpose. For instance, an access right may permit a user possessing the appropriate authentication credentials to operate a workstation, server, or virtual machine after “logging on” to the workstation. An access right may permit a user to instruct a computing device to perform some functions, while forbidding the performance of other instructions. As an example, an “administrator” or “root” user may have the ability to install and uninstall software on a computing device, as well as the ability to execute the software; an ordinary user may have the ability to execute software on the computing device, but not have the ability to install or uninstall the software. The computing device may be configured to ignore or refuse commands from a user that does not have a user account with the access right to instruct the computing device to execute those commands. In some embodiments, the access right gives a user the ability to access a particular network, such as a network 121 as described above in reference to FIGS. 1A-1B. In other embodiments, the access right controls the ability to access a particular network access point. The access right may affect the ability to access one or more master nodes of a network. The network may be a private network; for instance, the network may function as a “private internet” for the use of a community sharing a particular goal, set of ideals, or commercial interest. The private network may, for instance, be a trading or gambling network.

The access right may affect the ability to access or read messages directed to particular user account within a messaging service; for instance, the access right may control whether a particular user can read a particular email account, an instant message, a text message, or a voice over internet protocol stream. The access right may give a user the ability to decrypt an encrypted message; in some embodiments, where the access right is tied to the possession of a particular private key, an encrypted message or stream may be encrypted using the corresponding public key. The access right may give a user the ability to unlock the use of an application or suite of applications on a computing device; for instance, the user may be able to access communication sites concerning classes. The user may be able to access music on a cloud service or on a local computing device. The user may be able to access streaming media over a network if in possession of the access right.

The access right may give a security system the ability to lock out or allow entry to certain people peer-to-peer (P2P) network and to those files. The access right may control the ability to use an application-platform interfacing product, such as the DOCKER computer software produced by Docker, Inc. of San Francisco, Calif. The access right may control the ability of a user or computing device to access an application programming interface (API). The access right may control access to a particular file or set of files; for instance, the access right may lock access to confidential information, or information that could be used for identity theft, such as passport, social security, birth certificate data, permit data, data concerning licenses, data concerning escrowed property, legal documents such as wills, settlements or divorce decrees, or electronic access to physically locked devices such as safe-deposit boxes or the doors to vehicles or buildings. An access right may give a user the ability to run a particular software product; for instance, the license key permitting a software product to execute in a particular computing environment may be tied to a particular user account. An access right may determine a user's ability to access one or more files or classes of files. An access right may include a right to confer access right on another user; for instance, an administrative or root user may have the right to give other users ordinary user accounts. An administrative or root user may have the right to give other users administrative or root user accounts.

The access right may give the user the ability to view content on a website. In some embodiments, the user having an access right to view content can view all of the content of the website. In other embodiments, a particular access right gives the user the ability to view particular content, but not other content. For instance, where the website is an online newspaper, the website may sell specific stories to users independent of the paper as a whole; this may be implemented by selling the user an access right, as set forth in more detail below, where the access right gives the user the ability to view a particular story or set of stories, which may be what the user is ostensibly purchasing when acquiring the access right. The access right may be purchased using virtual currency. The access right may permit a user to access a portion of a path-concealing network, such as networks and rendezvous points provided by TOR, as produced by the TOR Project, Inc. of Cambridge, Mass.

Referring to FIG. 2 in further detail, the system 200 includes a data storage device 201. The data storage device 201 may be associated with a first entity. The first entity may be a person. The first entity may be a group of people. The first entity may be any entity formed by one or more people; for instance, the first entity may be a firm, such as a corporation or a partnership. The first entity may be a governmental body, such as an international, federal, state, provincial, or municipal government. The first entity may be a branch or department of government. The first entity may be any smaller division of any entity formed by one or more people; for instance, the first entity may be a department or within a branch of government. The first entity may be a department, branch, or other portion of a firm. The first entity may be a computing device 100 as defined above in reference to FIGS. 1A-1B. The first entity may be a plurality of computing devices 100 as defined above in reference to FIGS. 1A-1B. The first entity may be a server 122 as defined above in reference to FIGS. 1A-1B. The first entity may be a client device 120 as defined above in reference to FIGS. 1A-1B. The first entity may be a computer program as defined above in reference to FIGS. 1A-1B.

In some embodiments, the data storage device 201 is a non-transitory object capable of providing proof that the first entity possesses a private key. The data storage device 201 may be a code as described above in reference to FIGS. 1A-1B; for instance, the data storage device 201 may be a smart card or RFID tag. In some embodiments, the data storage device 201 is a computing device 100 as described above in reference to FIGS. 1A-1B. The data storage device 201 may be a server 122 as disclosed above in reference to FIGS. 1A-1B. The data storage device 201 may be a client device 120 as described above in reference to FIGS. 1A-1B. The data storage device 201 may be memory 103, 104 as described above in reference to FIGS. 1A-1B. The data storage device 201 may be a removable storage device 107 as disclosed above in reference to FIGS. 1A-1B; for instance, the data storage device 201 may be a fob or flash drive. The data storage device 201 may be a “wearable” device, such as GOOGLE GLASSES produced by Google Inc. of Mountain View, Calif., or the APPLE WATCH produced by Apple Inc. of Cupertino Calif. The data storage device 201 may be an optical disc drive, such as a compact disc (“CD”) or digital video disc (“DVD”) drive. The data storage device 201 may be a disc drive, such as a tape drive. The data storage device 201 may be a disc, such as a CD, DVD, or “floppy disc.” The data storage device 201 may be any other portable memory device, such as a thumb drive.

Data storage software may cause one or more computing devices to act as the data storage device 201. For instance, when the first entity is using a particular computing device to connect with the computing device 202 via a web browser, the computing device 202 may direct the first entity's computing to maintain proof that the first entity possesses a private key in a persistent cookie, so that when the first entity uses that computing device to contact the computing device 202 again, the data in the persistent cookie can be used automatically for authentication. The data storage device 201 may likewise be a computing device storing proof that the first entity possesses a private key in persistent storage such as provided for in the HTML 5 protocols. The data storage device 201 may be created by installing an application on a computing device. The data storage device 201 may be created by installing a plug-in on a computing device. The data storage device 201 may be created by associating a plugin, application, or persistent data object with a user account maintained on a server or cloud, which the first entity may direct, explicitly or implicitly, to provide the proof that the first entity possesses a private key as described in further detail below. As an example, the first entity may be presented with a widget that remains visible whenever the first entity is viewing web pages, the activation of which causes the proof of possession of the private key to be conveyed to the operator of the web page. In other embodiments, a second entity communicating with the data storage device 201 may have a widget or similar facility enabling the second entity to request the proof that the first entity possesses the private key.

The data storage device 201 is capable of providing proof that the first entity possesses a private key. In some embodiments, the data storage device 201 provides the private key, or a short representation of the private key, such as a shortener or pseudonym; for instance, the data storage device 201 may include a physical or virtual wallet as set forth in further detail below. In other embodiments, the data storage device 201 provides a digital signature signed by the private key; the data storage device 201 may contain a copy of a digital signature. The data storage device 201 may contain the private key and may be configured to create a digital signature using the private key; for instance, the data storage device 201 may be configured to produce a datum containing a timestamp, such as a timestamp containing the current date and time, sign it with the private key, and provide the resulting signature. The datum to be signed may be the one-time passcode output by a hard or soft token. The data storage device 201 may be configured to sign a datum received from another device, such as the computing device 202, as set forth in further detail below, and provide the resulting digital signature. In other embodiments, the data storage device 201 is configured to decrypt a datum that is encrypted with the public key associated with the private key, and to provide the decrypted datum as proof of possession of the private key.

The system 200 includes a first computing device 202. In some embodiments, the computing device 202 is a computing device 100 as disclosed above in reference to FIG. 1A. In other embodiments, the computing device 202 is a set of computing devices 100, as discussed above in reference to FIG. 1A, working in concert; for example, the computing device 202 may be a set of computing devices in a parallel computing arrangement. The computing device 202 may be a set of computing devices 100 coordinating their efforts over a private network, such as a local network or a virtual private network (VPN). The computing device 202 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the computing device 202 is a server 122 as disclosed above in reference to FIG. 1B. The computing device 202 may communicate with one or more additional servers 122. The computing device 202 and the one or more additional servers 122 may coordinate their processing to emulate the activity of a single server 122 as described above in reference to FIG. 1B. The computing device 202 and the one or more additional servers 122 may divide tasks up heterogeneously between devices; for instance, the computing device 202 may delegate the tasks of one component to an additional server 122. In some embodiments, the computing device 202 functions as a client device 120 as disclosed above in reference to FIG. 1B.

In some embodiments, the computing device 202 is configured to receive, from the data storage device 201, authentication information demonstrating possession of a private key. The computing device 202 may be configured to retrieve, from the audit chain 203, at least one crypto-currency transaction to an address associated with a public key corresponding to the private key. The computing device 202 may be configured to authenticate, based on the retrieved crypto-currency transaction, the first entity.

The system 200 includes an audit chain 203. In some embodiments, the audit chain 203 records a series of crypto-currency transactions in a way that preserves the order in which the crypto-currency transactions took place. In one embodiment, a crypto-currency transaction 204 is a collection of textual data stating that the owner of a certain transferable item represented in the transaction register is transferring that item to the owner of an address, signed by a digital signature created using the private key associated with the owner's public key, as described above in reference to FIGS. 1A-1B. For instance, the crypto-currency transaction 204 may describe a transfer of virtual currency, such as crypto-currency as described below. The virtual currency may be a digital currency. The crypto-currency transaction 204 may describe the transfer of an access right, as described above in reference to FIG. 2. The item of value may be a transfer of trust, for instance represented by a statement vouching for the identity or trustworthiness of the first entity. The crypto-currency transaction 204 may describe the transfer of a physical good; for instance, crypto-currency transaction may describe the sale of a product. In some embodiments, a transfer nominally of one item may be used to represent a transfer of another item; for instance, a transfer of virtual currency may be interpreted by the system 200 as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with the crypto-currency transaction by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland.

In one embodiment, an address is a textual datum identifying the recipient of virtual currency in a crypto-currency transaction 204. In some embodiments, the address is linked to a public key, the corresponding private key of which is owned by the recipient of the transaction. For instance, the address may be the public key. The address may be a representation, such as a hash, of the public key. The address may be linked to the public key in the memory of a computing device, for instance via a “wallet shortener” protocol. Where the address is linked to a public key, the transferee in the crypto-currency transaction 204 may record a subsequent transaction transferring some or all of the value transferred in the first transaction to a new address in the same manner.

The audit chain 203 may preserve the order in which the transactions took place by listing them in chronological order. The audit chain may preserve the order in which transactions took place by listing them in blocks, and placing the blocks in chronological order. The audit chain 203 may be a distributed, consensus-based ledger, such as those operated according to the protocols promulgated by Ripple Labs, Inc., of San Francisco, Calif., or the Stellar Development Foundation, of San Francisco, Calif. In some embodiments, the audit chain is a secured audit chain; in one embodiment, a secured audit chain is an audit chain having safeguards against alteration by unauthorized parties. The audit chain may be maintained by a proprietor, such as a system administrator on a server 122, that controls access to the audit chain; for instance, the user account controls may allow contributors to the audit chain to add crypto-currency transactions to the audit chain, but may not allow any users to alter crypto-currency transaction that have been added to the audit chain. In some embodiments, the audit chain is cryptographically secured; in one embodiment, an audit chain is cryptographically secured where each link in the chain contains encrypted information that makes it practically infeasible to alter the audit chain without betraying that alteration has taken place, for instance by requiring that an administrator or other party sign new additions to the chain with a digital signature. In some embodiments, the audit chain contains cryptographic hashes of information in the audit chain; the hashes may include hashes, such as Winternitz hashes, that are sensitive to even minor changes to the hashed data, owing to the cascade effect as described below, but are also impossible to perform without a secret key.

In some embodiments, the audit chain 203 is an immutable audit chain, which, once formed, cannot be altered by any party, no matter what access rights that party possesses. For instance, the audit chain 203 may include a hash chain, in which data is added during a successive hashing process to ensure non-repudiation. The audit chain may include a block chain 206. In one embodiment, the block chain 206 is an audit chain 203 that records one or more new crypto-currency transactions 204 in a data item known as a block 206a-b. An example of a block chain is the BITCOIN block-chain used to record BITCOIN transactions. The blocks 206a-b may be created in a way that places the blocks 206a-b in chronological order, and links each block 206b to a previous block 206a in the chronological order, so that any computing device may traverse the blocks 206a-b in reverse chronological order to verify any crypto-currency transactions 204 listed in the block chain 206. Each new block 206b may be required to contain a cryptographic hash describing the previous block 206a. In some embodiments, the block chain 206 contains a single first block, known as a “genesis block.”

The creation of a new block 206b may be computationally expensive; for instance, the creation of a new block 206b may be designed by a protocol accepted by all participants in forming the block chain 206 to take a powerful set of computing devices a certain period of time to produce. Where one block 206a takes less time for a given set of computing devices to produce the block 206a, the protocol may adjust the algorithm to produce the next block 206b so that it will require more steps; where one block 206a takes more time for a given set of computing devices to produce the block 206a, protocol may adjust the algorithm to produce the next block 206b so that it will require fewer steps. As an example, the protocol may require a new block 206b to contain a cryptographic hash describing its contents; the cryptographic hash may be required to satisfy a mathematical condition, achieved by having the block 206b contain a number, called a nonce, whose value is determined after the fact by the discovery of the hash that satisfies the mathematical condition. Continuing the example, the protocol may be able to adjust the mathematical condition so that the discovery of the hash describing a block and satisfying the mathematical condition requires more or less steps, depending on the outcome of the previous hashing attempt. The mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, the production of a new block 206b according to the protocol is known as “mining.”

In some embodiments, the protocol also creates an incentive to mine new blocks. The incentive may be financial; for instance, successfully mining a new block 206b may result in the person or entity that mines the block 206b receiving a predetermined amount of currency. The currency may be fiat currency. The currency may be crypto-currency as defined below. In other embodiments, the incentive may be redeemed for particular products or services; the incentive may be a gift certificate with a particular business, for instance. In some embodiments, the incentive is sufficiently attractive to cause participants to compete for the incentive by trying to race each other to the creation of blocks. Each block 206b created in the block chain 206 may contain a record or transaction describing one or more addresses that receive an incentive, such as virtual currency, as the result of successfully mining the block 206b.

Where two entities simultaneously create new blocks, the block chain 206 may develop a fork; the protocol may determine which of the two alternate branches in the fork is the valid new portion of the block chain 206 by evaluating, after a certain amount of time has passed, which branch is longer. “Length” may be measured according to the number of blocks in the branch. Length may be measured according to the total computational cost of producing the branch. The protocol may treat only crypto-currency transactions 204 contained the valid branch as valid crypto-currency transactions 204. When a branch is found invalid according to this protocol, crypto-currency transactions 204 registered in that branch may be recreated in a new block in the valid branch; the protocol may reject “double spending” crypto-currency transactions 204 that transfer the same virtual currency that another crypto-currency transaction 204 in the valid branch has already transferred. As a result, in some embodiments the creation of fraudulent crypto-currency transactions 204 requires the creation of a longer block chain branch by the entity attempting the fraudulent crypto-currency transaction 204 than the branch being produced by the rest of the participants; as long as the entity creating the fraudulent crypto-currency transaction 204 is likely the only one with the incentive to create the branch containing the fraudulent crypto-currency transaction 204, the computational cost of the creation of that branch may be practically infeasible, guaranteeing the validity of all crypto-currency transactions 204 in the block chain 206. In some embodiments, where the algorithm producing the blocks 206a-b involves a cryptographic hash using a well-designed hashing algorithm, attempts to avoid the computational work necessary to create the hashes by simply inserting a fraudulent transaction in a previously created block may be thwarted by the “avalanche effect,” whereby a small alteration of any data within the block chain causes the output of the block chain to change drastically; this means that alterations are readily detectable to any person wishing to validate the hash of the attempted fraudulent block.

Additional data linked to a crypto-currency transaction may be incorporated in blocks in the block chain; for instance, data may be incorporated in one or more fields recognized by block chain protocols that permit a person or computer forming a transaction to insert additional data in the block chain. In some embodiments, additional data is incorporated in an unspendable transaction field. For instance, the data may be incorporated in an OP_RETURN within the BITCOIN block chain. In other embodiments, additional data is incorporated in one signature of a multi-signature transaction. In an embodiment, a multi-signature transaction is a crypto-currency transaction to two or more addresses. In some embodiments, the two or more addresses are hashed together to form a single address, which is signed in the digital signature of the crypto-currency transaction. In other embodiments, the two or more addresses are concatenated. In some embodiments, the two or more addresses may be combined by a more complicated process, such as the creation of a merkle tree as described below. In some embodiments, one or more addresses incorporated in the multi-signature transaction are typical crypto-currency addresses, such as addresses linked to public keys as described above, while one or more additional addresses in the multi-signature transaction contain additional data related to the transaction; for instance, the additional data may indicate the purpose of the transaction, aside from an exchange of virtual currency, such as the item for which the virtual currency was exchanged.

The audit chain 203 may be a block chain ecosystem data structure. In one embodiment, a block chain ecosystem data structure is a data structure that is located outside a block chain but uses the block-chain as a basis for reliability or security by giving elements in the block chain ecosystem data structure a secure and reproducible relationship with elements within the block chain. In another embodiment, the block chain ecosystem data structure has a secure and reproducible relationship, as set forth in further detail below, with elements within another form of immutable audit chain; as a non-limiting example, the data structure may be linked to a consensus ledger rather than a block chain. The block chain ecosystem data structure may create the relationship by inserting representations of elements from the block chain ecosystem data structure into blocks in the block chain; for instance by “merge hashing,” where the elements are part of what gets hashed as block chain data during the hashing algorithm for blocks as described above. For example, in some embodiments, the audit chain 203 includes an alternative chain. In one embodiment, an alternative chain is one or more blocks (not shown) that are incorporated into a block chain 206, by including at least one hash representing data in the alternative chain in at least one block in the block chain 206 that is mined; where the mathematical puzzle involved in creating the new block is the production of a new hash, the additional hash in the block may not affect the degree of difficulty, and thus miners are not put at a computational disadvantage incorporating the alternative chain. The alternative chain may be incorporated using one or more hash trees, such as merkle trees (not shown). The merkle tree may a structure containing a hash of each datum in the alternative chain as leaf notes, with each internal node containing a hash of all of its child nodes; thus, by the avalanche principle, the root of a merkle tree may be a hash that recursively represents all the data hashed in the merkle tree, and thus a set of data in the alternative chain, so that incorporation of the root in a block in the block chain 206 amounts to incorporation of the data from the alternative chain that the merkle tree represents. A miner may charge a fee for incorporating the alternative chain in a block the miner mines. In an embodiment, verification of a transaction filed in the alternative chain involves first locating the transaction in the alternative chain, verifying its digital signature, and verifying each hash between that location and the block chain block (for instance by verifying each hash in the merkle tree from the leaf corresponding to the transaction to the root), verifying the hash of the block incorporating the alternative chain, and then verifying the block up the block chain as described above. In other embodiments, the hash tree is a tiger tree. In other embodiments, the alternative chain is linked to the block chain via a hash chain (not shown).

In some embodiments, data linking the block chain ecosystem data structure to the block chain is incorporated in an unspendable transaction field as described above in reference to FIG. 2. For instance, the data may be incorporated in an OP_RETURN within the BITCOIN block chain. In other embodiments, data linking the block chain ecosystem data structure to the block chain is incorporated in one signature of a multi-signature transaction. For example, the root of a merkle tree may occupy one or more addresses that are signed in a multi-signature transaction as described above in reference to FIG. 2.

In other embodiments, elements in the block chain ecosystem data structure are mapped to elements in the block chain by means of an agreed-upon mapping protocol. For instance, rather than inserting a hash from the block chain ecosystem into the block chain, an algorithm may establish a mathematical relationship between an element in the block chain ecosystem data structure and an element in the block chain; the mathematical relationship may be unique to the element in the block chain ecosystem data structure. The mathematical relationship may be unique to the element in the block chain. As a non-limiting example, elements in a block chain ecosystem data structure may be mapped to particular transactions in the block chain. Elements in the block chain ecosystem data structure may be mapped to particular addresses in the block chain. Elements in the block chain ecosystem data structure may be mapped to particular hashes corresponding to blocks. The mapping may be performed using digital signatures; for instance, the owner of a private key corresponding to a public key represented by an address in the block chain may sign an element in the block chain ecosystem with the private key. Each element in the block chain may be hashed, and the space containing all hashes may be mapped to elements in the block chain using a mathematical algorithm.

In other embodiments, the block chain ecosystem data structure may incorporate a side chain. In some embodiments, a side chain is a block chain that is operated parallel to a main block chain, using transactions or transaction outputs extracted from and later merged back into the main block chain via two-way pegging. The transactions or transaction outputs may be merged back into the main block chain by performing a combined hash of the latest link in the side chain with the latest link in the block chain. The combined hash may use a merkle tree as described above to reduce the computational difficulty associated with a combined hash of two entire blocks.

The block chain ecosystem data structure may include a peer-to-peer storage protocol. A peer-to-peer storage protocol may be a protocol for storing data in a distributed fashion among nodes in a network such as the Internet. As one example, the peer-to-peer storage protocol may be a distributed hash table (“DHT”). In one embodiment, a DHT maps elements of data, such as data files or the names of data files, to keys in a keyspace. The keys may be created by hashing the elements of data; for instance, all keys in the keyspace of a particular DHT may be created by hashing each element of data using a hashing algorithm, such as the Secure Hash Algorithm (“SHA-1”), producing uniformly sized keys having sensitive and reproducible relationships to the data elements to which they correspond. The DHT may define a “distance” function within the key space that assigns any pair of keys a distance, analogous to geometric distance, between the pair of keys. The DHT may include an overlay network, which labels data storage elements, such as memories of computer devices as described above in reference to FIGS. 1A-1B, as nodes in the network; each node in the overlay network may provide information, for each key, that indicates either that the key corresponds to data stored at that node, or that a proximal node stores keys closer to the key according to the distance function. In some embodiments, keys are assigned to nodes in the overlay network according to their distances, so that adjacent nodes in the network have keys that are close to each other according to the distance function. In other embodiments, where particular nodes must possess particular data, the topology of the overlay network shifts, in response to data acquisition, so that adjacent nodes have closer keys. The data may be secured: security protocols may prevent one node from accessing the data possessed by another node without authentication information pertaining to the possessing node, such that the only freely available information in the DHT is the set of keys and the information concerning nodes possessing their corresponding data. In some embodiments, some data in the DHT is secured and other data is not secured. Keys from the DHT may be included in the block chain via merge hashing; the keys may be incorporated via a merkle tree. In some embodiments, the audit chain 203 includes a master list document containing all hashes of all keys; the master list document may be hashed in turn to form a “master hash,” which is inserted into a block chain. Each of a series of master hashes or each of a series of merkle trees may be indexed, and the indices linked to particular batches of data. For instance, if the data in question includes the vehicle identification numbers (“VIN”) of cars, each year of vehicles may be collected in a master hash list or merkle tree with a particular index number; master hash lists or merkle trees could be further subdivided by other categories, such as make, model, or color of cars; as a result, the retrieval of a given set of keys may not require reviewing the entire key set. Keys may be incorporated via an alternative chain. Keys may be incorporated via a side chain. In some embodiments, keys are further organized in a database to allow for faster retrieval; the database may involve divisions into categories as for master hash lists or merkle trees.

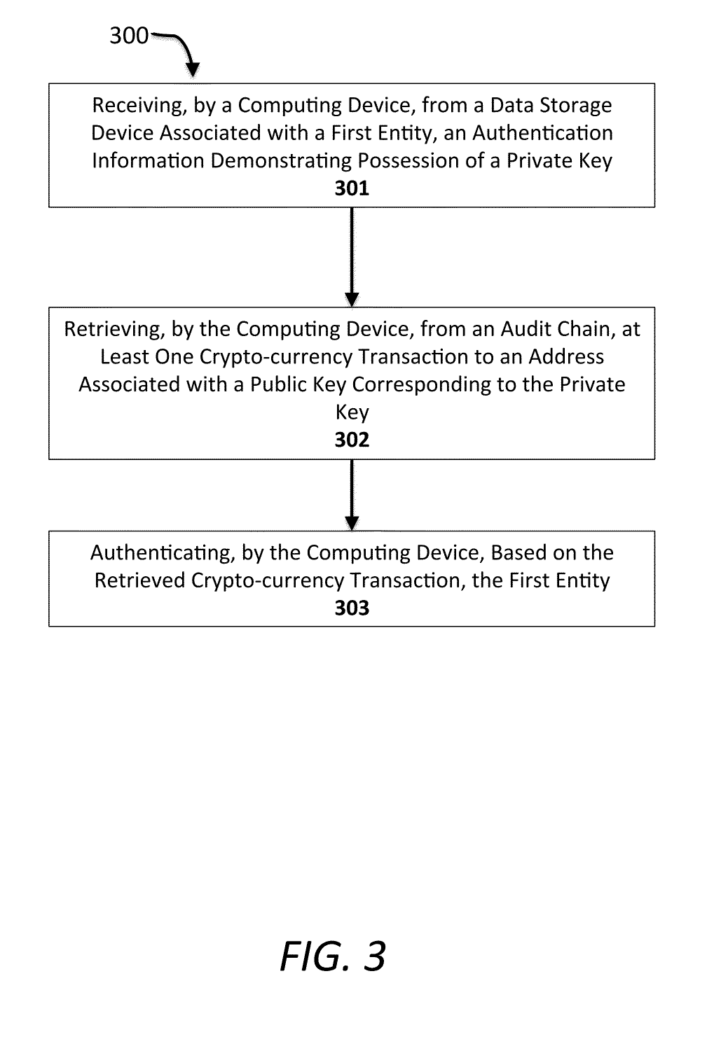

In some embodiments, the audit chain 203 is copied in its entirety to each computing device participating in the use of the system 200. In other embodiments, the audit chain 203 is copied to some computing devices but not to others; for instance, where the audit chain 203 is a block chain or a consensus ledger created for exchanges of virtual currency or other commercial exchanges, the audit chain 203 may be copied to all computing devices participating in such exchanges, while devices using transactions in the audit chain 203 for authentication as set forth in reference to FIGS. 2-3 may not necessarily receive an entire copy of the audit chain 203. In other embodiments still, various components of the audit chain are distributed to various computing devices, such as the nodes in a DHT. Where the audit chain is centralized, computing devices that do not possess a copy of the audit chain 203 may obtain information from and convey information to the audit chain 203 by communicating with the computing device or set of computing devices on which the centralized audit chain 203 is maintained. Where the audit chain is decentralized and multiple copies of the entire audit chain 203 are distributed to multiple computing devices, computing devices that do not possess a copy of the audit chain 203 may obtain information from and convey information to a copy of the audit chain 203 residing on a computing device that does have a copy; requests for information and changes to the audit chain 203 may be propagated to all other computing devices having copies of the audit chain 203. In some embodiments, the algorithm selecting the initial computing device with which to communicate may also follow load-balancing and efficiency-related protocols in making the initial selection. Where the audit chain 203 includes a data structure distributed among computing devices, as in a DHT, computing devices may communicate with the audit chain 203 using the protocol for information storage and retrieval used in the data structure. In some embodiments, a combination of the above methods are used for distribution and storage of the audit chain 203; for instance, the audit chain 203 may include a DHT that is distributed among a first network of computing devices, and that is hashed into a block-chain copied onto each of a second network of computing devices, so that retrieval from or modification to the audit chain 203 involves both following the DHT protocol to locate the relevant transactions in the DHT, and either modifying or verifying the block chain on each of the block chain copies in the second network. Continuing that example, the first network and second network may not fully overlap. Any machine receiving part or all of the audit chain 203 may store the audit chain 203 locally or in a cloud environment; for instance, a computing device may “dock” all or part of the audit chain 203, as well as software necessary for using or accessing the audit chain 203, using a DOCKER as described above.

In some embodiments, the virtual currency is traded as a crypto-currency. In one embodiment, a crypto-currency is a digital, currency such as Bitcoins, Peercoins, Namecoins, and Litecoins. The crypto-currency may be a clone of another crypto-currency. The crypto-currency may be an “alt-coin.” The crypto-currency may be decentralized, with no particular entity controlling it; the integrity of the crypto-currency may be maintained by adherence by its participants to established protocols for exchange and for production of new currency, which may be enforced by software implementing the crypto-currency. The crypto-currency may be centralized, with its protocols enforced or hosted by a particular entity. For instance, the crypto-currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. The mathematical puzzles may be the same as the algorithms used to make productions of blocks in a block chain 206 computationally challenging; the incentive for producing blocks may include the grant of new crypto-currency to the miners. Quantities of crypto-currency may be exchanged using crypto-currency transactions 204 as described above in reference to FIG. 2.

In some embodiments, the owner of crypto-currency keeps his or her currencies in a crypto-currency wallet, which is defined as any facility that stores crypto-currency. The storage of crypto-currency may be the storage of the public and private keys associated with crypto-currency received by the owner. In some embodiments, the user stores the crypto-currency in a virtual wallet, which is located at what amounts to a “crypto-currency bank”; the virtual wallets are exchanges and firms that are located through the Internet. The virtual wallets may accept fiat as payment and provide the user with crypto-currency or other chosen crypto-currencies to hold within their virtual account. In other embodiments, the user keeps crypto-currency in a local wallet, which is a storage device (i.e. hard drive, memory device) that the user can physically move and store in any manner he or she wants. If a user with a local wallet wants to use his or her crypto-currency the user must hook it back up to a computer device that has wallet software on it and then he or she can move the crypto-currency around. In other embodiments, the user keeps crypto-currency in a physical wallet that stores one or more addresses associated with the crypto-currency in physical form, in addition to the corresponding private keys permitting expenditure as described below, such as a paper wallet in which a user prints out his or her crypto-currency from his or her local wallet storage device or his or her virtual wallet. A paper wallet may be a piece of paper with one or more QR codes on it that, once scanned, can be put on a local or virtual wallet or spent by scanning the QR codes right into a point of sale system. A physical wallet may keep the private and public keys associated with crypto-currency in any code readable by a code scanner as described above in reference to FIGS. 1A-1B.

Wallets may have “cold storage” or “hot storage.” Since the rampant hacking and stealing of bitcoin wallets that has been done firms have created “cold storage.” “Cold storage” is storage of one's crypto-currency in a location that is not connected to the Internet and sometimes is not even located where virtual wallets are kept. Virtual wallets refer to “hot storage” or “hot wallet” as a term that their contents are exposed to hackers via the virtual wallets. These “hot wallets” are full of coins being used. References to hot and cold wallets are now main-stream for wallet companies. The ratio of hot to cold wallets is usually 10% or 20% hot and 80% to 90% cold. The transfer either virtually or physically back and forth between the wallets internally to have security confidence. In the end, all kinds of crypto-currency wallets may be place to store private and public keys, confirmed by the block chain, but equate to funds or fiat currency.

In some embodiments, information such as the private keys or public keys associated with transactions is maintained in a private register (not shown). The private register may include a data store or data structure permitting the computing device 202 to retrieve the information rapidly. The private register may include a database 112 as described above in reference to FIGS. 1A-B. The private register may link the public keys to their corresponding private keys. The private register may include certificates, or information required to create certificates, from one or more certificate authorities that issued private or public keys in the private register; the private register may link certificates or information for creating certificates to the corresponding private or public keys. Persons skilled in the art will be aware of many ways to link one datum to a related datum; for instance, a private key, its corresponding public key, and information identifying an issuing certificate authority may be three cells in a database row in a database included in the private register, so that retrieval of the row using a query specifying any of the three, or a set of data containing any of the three, will produce the other two. The private register may contain additional data; for instance, the private register may contain records describing transactions involving each private or public key, information identifying the entities involved in the transactions, or information identifying the address to which the transactions were conveyed.

Some embodiments of the system include a second computing device 205. In some embodiments, the second computing device 205 is a computing device 100 as disclosed above in reference to FIG. 1A. The second computing device may be any combination of computing device 100 as described above for the first computing device 202, in reference to FIG. 2. The second computing device 205 may be the first computing device 202. The second computing device may file one or more crypto-currency transactions 204 as set forth in further detail below.

The system 200 may include one or more devices capable of secondary or additional authentication. For instance, the system 200 may include a token (not shown) that stores further authentication information. The token may be an in-app token. The token may generate authentication information according to a timed protocol in synch with a protocol running on a device accessible to the computing device 202, so that the generated authentication information may be required for verification of possession of the token; the protocol may essentially reproduce a one-time pad in electronic form. The token may be a hard token implemented using circuitry. The token may be a soft token, running as a computer program on a computing device 100 as disclosed above in reference to FIGS. 1A-1B. The system 200 may include a communication device by means of which the first entity may be contacted for secondary authentication; the communication device may be a computing device 100 as disclosed above in reference to FIGS. 1A-1B. For example, the communication device may be a mobile telephone, kiosk, or tablet.

FIG. 3 illustrates some embodiments of a method 300 for crypto-currency transaction authentication. The method 300 includes receiving, by a computing device, from a data storage device associated with a first entity, an authentication information demonstrating possession of a private key (301). The method 300 includes retrieving, by the computing device, from an audit chain, at least one crypto-currency transaction to an address associated with a public key corresponding to the private key (302). The method 300 includes authenticating, by the computing device, based on the retrieved crypto-currency transaction, the first entity (303).

Referring to FIG. 3 in greater detail, and by reference to FIG. 2, the method 300 includes receiving, by a computing device, from a data storage device associated with a first entity, an authentication information demonstrating possession of a private key (301). In some embodiments, the entity associated with the data storage device 201 initiates an access request for which the computing device 202 requires authentication. For instance, the entity associated with the data storage device 201 may be attempting to access a secured application or web page operated by the computing device 202, requiring the entity to “log on” by submitting the authentication information. Where the data storage device 201 is a code or smart card, the first entity may cause a code scanner or similar facility coupled to the computing device 202 to extract the authentication information from the data storage device 201. Where the data storage device 201 is a memory as disclosed above in reference to FIG. 2, the first entity may couple the data storage device 201 to the computing device 201. Where the data storage device 201 is a device capable of near-field communication with the computing device 202, the entity may cause the data storage device 201 to transmit the authentication information via the near-field communication; for instance, a person who is the first entity may transmit the authentication information from a smart-phone or RF-enabled fob. In other embodiments, the entity may attempt to install software on the data storage device 201, prompting a license verification script automatically to request the authentication information, and to arrange for the data storage device. The data storage device 201 may transmit the public key to the computing device 202. The data storage device 201 may transmit a datum associated with the public key, such as an address, to the computing device 202.

In some embodiments, the computing device 201 transmits a challenge to the data storage device 202, which responds to the challenge in a way that conveys some or all of the authentication information. The computing device 201 may transmit a challenge datum to the data storage device and receive a digital signature signing the challenge datum from the data storage device; for instance, the computing device 201 may send a randomly generated code to be signed with the private key, to ensure that the digital signature is being generated on the spot, and is not simply being recycled by a party that intercepted a past digital signature. The challenge may request that the data storage device 201 sign a datum that includes a current timestamp generated by the data storage device 201. The data storage device 201 may alternatively incorporate a randomly generated one-time code or a timestamp in the digitally signed information without a challenge, by following a common protocol adopted to implement an embodiment of this method. In other embodiments, the computing device 202 transmits a message encrypted with the public key to the data storage device 201; the data storage device 201 may then decrypt the message with the private key. The computing device 202 may receive the decrypted version of the message from the data storage device 201 as part of, or all of, the authentication information. The communication of the proof of the first entity's possession of the private key may be accomplished using protocols including the signed public key and challenge (SPKAC) protocol, digital certificates, any form of public key infrastructure (PKI), or any form of digital signature standards including dynamic digital certificates.

The method 300 includes retrieving, by the computing device, from an audit chain, at least one crypto-currency transaction to an address associated with a public key corresponding to the private key (302). In some embodiments, the at least one crypto-currency transaction 204 is a transaction from a second entity to the first entity; for instance, the second entity may confer one or more access rights to the first entity using the at least one crypto-currency transaction 204, as set forth in further detail below. The at least one crypto-currency transaction may be one or more crypto-currency transactions that confer some value in virtual currency to the first entity. The at least one crypto-currency transaction 204 may be one or more crypto-currency transactions that confer some other value to the first entity, for instance using a colored coin system as described above in reference to FIG. 2. The second entity may be a trusted third party, for instance vouching for the identity of the first entity by means of the crypto-currency transaction 204. In some embodiments, the computing device 202 files the at least one crypto-currency transaction 204; for instance, the computing device 202 may earlier have filed the crypto-currency transaction to provide the first entity with authentication information or access rights after establishing the identity of the first entity by other means.

The second entity may file the at least one crypto-currency transaction by generating a block in the block chain, as described above in relation to FIG. 2. The second entity may then use the block to generate many transactions 204 by “selling” itself small fractions of the virtual currency or other transferable items associated with the block; in some embodiments, “selling” and “buying” transferable items means attaching the output of a transaction to the transferable items. For instance, where the second entity is the entity operating a security system, the second entity may “mine” blocks and then use transactions from mined block to confer access rights, as described below. In another embodiment, the second entity files the at least one crypto-currency transaction by purchasing crypto-currency from a third party. In some embodiments, the third party is a miner who gained a portion of the virtual currency corresponding to a block 206a in the block chain 206. In other embodiments, the third party is any possessor of crypto-currency within a system for exchanging crypto-currency. In some embodiments, the second entity may purchase one quantity of virtual currency, and then divide that quantity very finely to produce many transactions 204 by means of “purchasing” the virtual currency from itself; thus, the cost per transaction of purchasing the virtual currency may be extremely small. In other embodiments, the at least one crypto-currency transaction 204 includes a crypto-currency transaction purchasing the output of a previous crypto-currency transaction; for instance, an earlier crypto-currency transaction may be purchased by an entity having an access right, and a later transaction may record the transfer of the access right from that entity to another entity. In some embodiments, the at least one crypto-currency transaction 204 describes the transfer to which it corresponds; for instance, the at least one crypto-currency may describe an access right being transferred as part of the at least one crypto-currency transaction 204.

The method 300 includes authenticating, by the computing device, based on the retrieved crypto-currency transaction, the first entity (303). In some embodiments, the computing device 202 authenticates the first entity by authenticating a second entity that filed the at least one crypto-currency transaction 204, and determining that the at least one crypto-currency transaction represents an act of authentication of the first entity by the second entity; the authentication of the second entity may be implemented using any technique described in reference to FIG. 3 for authenticating the first entity. For example, the computing device 202 may retrieve another crypto-currency transaction from a third entity to the second entity; the third entity may be a trusted third party, or the computing device 202 may authenticate the third entity according to any technique described in reference to FIG. 3 for authenticating the first entity. In some embodiments, authenticating the second entity involves determining that the second entity is a trusted third party. As an example, the second entity may be an administrator entrusted with granting or revoking access rights for the computing device 202. The second entity may be a certificate authority. The second entity may have access rights regarding the computing device 202 that include the ability to confer some or all of the access rights enjoyed by the second entity to another entity by means of a crypto-currency transaction. The second entity may be any entity that deals with commerce, either in physical goods or intangible goods. The second entity may create a non-centralized security authority and implement the verification process of the non-centralized security authority using the method 300. For instance, a retailer may enact the authentication method 300 from any of its locations; in some embodiments, the local locations' security systems may use the method 300 while the parent company does not use the method. Likewise, a franchise owner may enact its own program to authenticate its own network of computers using the method 300 but be outside of the overall parent company's policy.

In some embodiments, the computing device 202 authenticates the first entity by determining a reputation of the first entity based on the at least one first crypto-currency transaction. The first entity may be required to establish a fixed identity in a market associated with the audit chain 203 or the crypto-currency transactions registered with that audit chain 203; in that case, the crypto-currency transaction 204 may be linked to the fixed identity of the first entity. The fixed identity may be established by submission by the first entity of other information concerning the first entity, such as social security numbers, tax identification numbers, credit scores, consumer reports, bank or credit card account information, corporate or other business firm filings, or biometric information. The information included to establish the fixed identity may include any information required for anti-money laundering protocols. The information included to establish the fixed identity may include any information required for “know your client” or “anti-money laundering” regulatory identification protocols. In other embodiments, the first entity has a datum that functions as unique identifier of the first entity. The unique identifier may be produced according to the Universally Unique Identifier (UUID) protocol. The unique identifier may be produced according to the Globally Unique Identifier (GUID) protocol. The computing device 202 may produce the identifier. The computing device 202 may require the first entity to obtain the identifier upon initial contact with the first entity. An entity implementing the system 200 and method 300 may require the first entity to obtain the identifier and link the identifier to particular transactions.

In some embodiments, the computing device 202 may analyze one or more additional crypto-currency transactions associated with the first entity. The computing device 202 may calculate a trustworthiness score for the first entity; the trustworthiness score may be displayed to a user of the computing device 202; for instance, the trustworthiness score may be displayed via a widget as described above in reference to FIG. 2. The trustworthiness score may be calculated using information gathered from the transactions performed by the first entity; for example, the trustworthiness score may be lowered for each attempt at double spending by the first entity. The trustworthiness score may be based in part by reviews of transactions involving the first entity by recipients of crypto-currency transactions from the first entity. The reviews may be visible to users. In some embodiments, reviewers' trustworthiness scores are visible to users, to allow users to consider the reviews in context of the reviewers' trustworthiness. In other embodiments, the computing device 202 weights reviews according to the reviewers' trustworthiness scores; for instance, where the trustworthiness scores are represented as positive numbers, a numerical rating from each reviewer may be multiplied by the reviewer's trustworthiness score. As a result, reviewers with high trustworthiness scores may make a greater contribution to the trustworthiness calculation than reviewers with low trustworthiness scores.

The computing device 202 may authenticate the first entity using the determined reputation by permitting access only to entities having a trustworthiness score above a certain threshold. The computing device 202 may assign a level of access to the first entity based on the level of the trustworthiness score; for instance, a high level of access may be given to an extremely trustworthy first entity, a lower level of access may be given to a first entity having a somewhat problematic trustworthiness score, and no access may be given to a first entity having a low trustworthiness score. The computing device 202 may set threshold amounts regarding other scores, such as customer satisfaction; for instance, the financial value of a transaction that the computing device 202 will allow the first entity to engage in may be related to a customer satisfaction score. The computing device 202 may also refuse to authenticate or grant access to a first entity whose reputation contains one or more instances of certain behaviors; for instance, if the first entity makes a double spending attempt or engages in other behavior suggesting fraud, the computing device 202 may not authenticate the first entity. The computing device 202 may collect qualitative indicia of the reputation of the first entity, such as customer or transaction-partner reviews, and present them to a user of the computing device 202; the user of the computing device 202 may enter an instruction to authenticate, or not authenticate, the first entity based on a perusal of the provided qualitative indicia.

In other embodiments, the computing device 202 authenticates the first entity by determining the commercial nature of the at least one crypto-currency transaction 204. As an example, the first entity may be presenting itself as a particular business, and a second entity that registered the at least one crypto-currency transaction 204 may share information with the computing device 202 that indicates the at least one crypto-currency transaction 204 was a transaction that the second entity paid to that particular business for a service or product that the business conveyed to the second entity. In some embodiments, the second entity is the entity operating the computing device 202; for instance, the authentication may be verification that the first entity is a business with which the second entity has transacted business in the past, as an anti-phishing safeguard. In other embodiments, the first entity is not attempting to portray itself as a specific business, but as a pseudonymous or anonymous entity that engages in a particular kind of commercial activity, which the computing device 202 may authenticate by determining that the at least one crypto-currency transaction 204 was made pursuant to that kind of commercial activity; for instance, the first entity may be portraying itself as a seller of used books, and the at computing device 202 may verify that the least one crypto-currency transaction 204 represents payment for a used book. The computing device 202 may combine this commercial category authentication with assessments of the reputation of the first entity, as described above; for instance, the computing device 202 may view customer reviews or other reviews associated with the at least one crypto-currency transaction 204.

In some embodiments, the computing device 202 authenticates the first entity by determining a financial value of the at least one crypto-currency transaction 204. In some embodiments, the financial value of the at least one crypto-currency transaction 204 is a further verification check on a commercial transaction the first entity claims to have engaged in; for instance, where the first entity claims the crypto-currency transaction 204 represented the sale of a used car, the computing device 202 may verify that the value of the crypto-currency transaction 204 was consistent with the price of a used car, for instance by further referencing indices of car values based on make, model, and depreciation. In other embodiments, the at least one crypto-currency transaction 204 may function as a pledge of collateral to offset financial risk imposed by authenticating the first entity. For instance, after verifying that virtual currency represented in the output of the at least one crypto-currency transaction 204 has not yet been conveyed to another entity via additional transactions, the computing device 202 may request that the first entity transfer some or all of that virtual currency to a party that will hold the currency in escrow for some period of time. As an example, if the computing device 202 has determined that the first entity is not trustworthy, or that there is insufficient information to determine that the first entity is trustworthy, the computing device 202 may allow a certain amount of access to the first entity while the virtual currency is available to cover the risk attendant to permitting the first entity to have that access level; the amount necessary to offset the risk may be determined using a weighted cost-benefit analysis, a worst-case scenario analysis, or by any other statistical or probabilistic measure of risk.

In some embodiments, authenticating further comprises determining an identity of the first entity. As noted above, in some embodiments, the computing device 202 may possess information suggesting that the recipient of the at least one crypto-currency transaction 204 was a particular entity. In other embodiments, the computing device 202 possesses access to identifying information the first entity previously submitted; for instance, the first entity may have provided identifying information to the computing device 202 or to another device capable of sharing the information to the computing device 202 prior to engaging in past activity; the at least one crypto-currency transaction 204 may have been performed as part of that activity, or used as part of the authentication process for that past activity, linking the private key associated with the receiving address of the at least one crypto-currency transaction 204 with that identifying information. In this context, for instance, the private key, may function as previously established password for the first entity to use when communicating with the computing device 202. Identifying the first entity may serve as the basis for authenticating a user attempting to log on to a computing device, network, virtual machine, or cloud service. Likewise, identifying the first entity may be used to authenticate a user attempting to use an application or to modify something within an environment. The computing device 202 may also perform anti-phishing analysis by attempting to identify the first entity; in one embodiment, where the computing device 202 cannot identify a first entity holding itself out as a particular business or individual, the computing device 202 warns a user that the first entity may be a phisher. In other embodiments, when the computing device 202 successfully identifies the first entity, the computing device compares the identity of the first entity to the identity the first entity claims to have; a mismatch may cause the computing device 202 to warn a user of possible phishing. In some embodiments, determining the at least one access right involves identifying the first entity, and retrieving an access right previously associated with the first entity.

In some embodiments, authenticating involves determining at least one access right of the first entity. In some embodiments, the computing device 202 determines the at least one access right by determining that a second entity possesses at least one access right, and determining that the at least one crypto-currency transaction represents a transfer of the at least one access right possessed by the second entity to the first entity. For example, the system 200 may be configured to allow the second entity to convey the second entity's access right to another entity; the second entity may lose its own access right in transferring its access right to the first entity. The computing device 202 may give the second entity the ability to “loan” access to the first entity, allowing the first entity to enjoy the access right instead of the second entity temporarily; the duration of the first entity's possession of the at least one access right may be a certain amount of time after the at least one crypto-currency transaction is filed. The duration of the first entity's possession of the at least one access right may be until the first entity registers another crypto-currency transaction giving the at least one access right back to the second entity. The duration of the first entity's possession of the at least one access right may be until the second entity files another crypto-currency transaction taking back the at least one access right. In other embodiments, the second entity has access rights permitting the second entity to confer at least one access right on the first entity, and the at least one crypto-currency transaction may represent the second entity conferring at least one such access right on the first entity. Entities may sell or lease access rights to one another; for instance, a transaction describing the transfer of an access right from a second entity to the first entity may be linked by the system 200 to a payment by the first entity for the access right. The transaction may be linked to an agreement to lease or purchase the access right. The system 200 may include a market for sale or leasing of access rights. The ability to buy, sell, or lease access rights may depend on an entity's trustworthiness score as described above in reference to FIG. 3.

In other embodiments, the authentication process may be used to link a particular resource to the first entity. For instance, the at least one crypto-currency transaction may identify a particular computing device as linked to the first entity. The at least one crypto-currency transaction may identify a network location as linked to the first entity.

In some embodiments, authentication involves retrieving a value that the first entity committed during a cryptographic commitment scheme. In one embodiment, a cryptographic commitment scheme is a protocol allowing an entity to commit to a chosen value, referred to as the “committed value,” while keeping it hidden from others; the value may be revealed to others a later point in time. The cryptographic commitment scheme may be designed so that the entity cannot change the value or statement the entity committed to after the fact. In one embodiment, the first entity files a crypto-currency transaction 204 in the audit chain 203 enabling the retrieval of the value to which the first entity wishes to commit. The transaction 204 may enable retrieval by containing the value. The transaction 204 may enable retrieval by containing a hash of the value. The transaction 204 may enable retrieval by containing data pointing to another location containing the value or a hash thereof; for instance, the transaction 204 may link itself to a datum stored within a block chain ecosystem data structure as disclosed above in reference to FIG. 2. Where the audit chain 203 is immutable, the first entity will be unable to change the transaction after it has been entered in the audit chain, satisfying the requirement that the committed value be impossible to change after commitment; for instance, if the audit chain 203 is a block chain or a consensus ledger, once the crypto-currency transaction 204 is accepted, no entity may be able to modify the contents of the transaction 204. In other embodiments, where the control of the audit chain 203 is centralized, the controller of the audit chain 203 may enforce a rule making it impossible to change at least the crypto-currency transaction 204 being used for a commitment scheme.

In some embodiments, the first entity files the crypto-currency transaction 204 anonymously. In other embodiments, the first entity files the crypto-currency transaction 204 pseudonymously. The requirement that other persons or entities be unable to detect the value of the commitment may be satisfied by the fact that the other persons or entities have no way to determine which transaction the first entity has filed. In other embodiments, the first entity prevents other entities from detecting the committed value by cryptographically securing the encrypted value. The first entity may cryptographically secure the committed value by producing a cryptographic hash of the committed value. Upon revealing the value, other entities may be able to verify that it is the committed value by repeating the hashing algorithm used to create the initial hash; the hash may be created using an algorithm exhibiting the cascade effect, so that the first entity would be unable to modify the committed value without resulting in a hash differing during the commitment scheme. In other embodiments, the first entity encrypts the value; the first entity may encrypt the value using the public key in a public key cryptographic system. The public key may be the public key associated with the private key used to sign the transaction 204. The public key may be the public key associated with the address to which the transaction 204 is made. As before, the first entity may reveal the committed value by providing the decrypted value to one or more entities; the entities may check that the provided value matches the committed value by encrypting the provided value using the public key. The first entity may prove that the first entity filed the crypto-currency transaction 204 using a digital signature signed with the private key used to sign the crypto-currency transaction 204.

In some embodiments, authentication involves participation in a secret sharing scheme. In one embodiment, a secret sharing scheme is a method for distributing a secret amongst a group of participants, each of whom is allocated a share of the secret. The secret may be reconstructed only when a sufficient number of shares combine together; in some embodiments, individual shares are of no use on their own for the purpose of guessing the secret. In some embodiments, the secret sharing scheme is verifiable; in an embodiment, a secret sharing scheme is verifiable when some auxiliary info is included when the secrets are shared that allows participants to verify the shares contributed by each participant are consistent. In some embodiments, where the secret is also a combination of information provided by the participants, participants in the secret sharing scheme are unable to guess the shares provided by other participants because sharing is performed via oblivious transfer, wherein each participant provides two or more shares, and the algorithm selecting shares does not permit the participant to determine which share is being used for the secret sharing scheme. In some embodiments, the first entity provides a share in a secret sharing scheme by creating, in the audit chain 203, a crypto-currency transaction 204 enabling the retrieval of the share. The crypto-currency transaction may enable the retrieval of the share as described above for commitment schemes, in reference to FIG. 3. The first entity may file crypto-currency transactions enabling access to a plurality of shares, for the purpose of oblivious transfer. The provision of the shares may be combined with the commitment scheme described above in reference to FIG. 3; for instance, each participant in the secret sharing scheme may initially commit to shares, and the revelation of the committed shares may precede assembling the secret.

In some embodiments, authentication involves performing a zero-knowledge proof. In one embodiment, a zero-knowledge proof is a method by which one party (the prover) can prove to another party (the verifier) that a given statement is true without conveying any info, apart from the fact that the statement is indeed true; as a result, the verifier (or another party who has recorded the proof) is unable to perform the zero-knowledge proof in turn. In one embodiment, a crypto-currency transaction 204 includes data indicating that a given statement is true. The statement may concern the recipient of the crypto-currency transaction 204. The data may be a statement, for instance, the data may be a statement by a known, verifiable, or trusted party. The data may be the information that the originator of the transaction has committed a value in the transaction. The data may be a piece of encrypted information. The data may be information that enables retrieval of information, as described above for commitment schemes in reference to FIG. 3; the information may be encrypted.

In some embodiments, the first entity performs a zero-knowledge proof that the first entity is the recipient of the transaction by digitally signing a datum provided by the verifier using a private key associated with the address to which the transaction 204 is directed; the datum may be randomly generated. The first entity may perform the proof by decrypting a datum that the verifier encrypted using a public key associated with the private key. In other embodiments, the first entity proves that the first entity originated the transaction by signing or decrypting data as described above using the private key used to sign the crypto-currency transaction 204. The proof may be proof that the first entity has committed to a value, which may be encrypted; the proof may not be strictly zero-knowledge with respect to the value itself, which may at least be available in encrypted form. The proof may be proof that the first entity was the provider of a share in a secret sharing scheme. The proof generally may be that the first entity is either the originator or recipient of the transaction 204, and thus has some relationship with the statement.

In another embodiment, the first entity performs a zero-sum proof by interaction with a verifier; for instance, the verifier may wish the first entity to provide zero-sum proof of possession of secret knowledge. The verifier may provide one or more inputs in the form of a series of randomly selected bits (or alternatively a randomly generated number that is encoded or translated to binary form); the first entity make one or more crypto-currency transactions 204 enabling the retrieval, as described above for commitment schemes in reference to FIG. 3, of one or more outputs created in response to the inputs; the generation of the outputs may require either the possession of the secret data to be verified, or a series of highly unlikely guesses. Alternatively, the first entity may provide information enabling the retrieval of the outputs and sign the provided information using either the private key used to generate a crypto-currency transaction 204, or the private key associated with the recipient address of the crypto-currency transaction 204. In either case, the verifier may be able to prove that the first entity, and not an imposter, provided the outputs, using the authentication methods described above in reference to FIG. 3.

In some embodiments, a second entity registers a second crypto-currency transaction to the first address. For instance, the second entity may be the entity operating a security system, and may confer different access rights using different crypto-currency transactions. A first crypto-currency transaction, for instance, may grant the first entity the right to access a network, while a second crypto-currency transaction gives the first entity the right to execute a particular software product.

In some embodiments, one or more crypto-currency transactions are reversed; for instance, an entity in charge of controlling access to a system may revoke one or more access rights of the first entity. The reversal may involve removing a crypto-currency transaction from the audit chain 203. The reversal may involve entering an additional crypto-currency transaction transferring the amount, or output, of the at least one crypto-currency transaction back to the originator of the at least one crypto-currency transaction. In other embodiments, such as when the private key is used to perform an illegal act, to compromise security in some way, or to harm the accessed computing device or network, all transactions to the address associated with the first entity are recalled, by undoing the transactions; in other embodiments, all transactions to the address of the product are reversed, by recording a second set of transactions representing revocations of the access rights.

In some embodiments, the computing device 202 checks one or more supplemental sources of authentication. The computing device 202 may employ two-factor authentication (“2FA”), in which it combines two authentication processes to authenticate the first entity. The computing device 202 may employ three-factor authentication (“3FA”). In some embodiments, the computing device 202 uses four or more factors to authenticate the first entity. The computing device 202 may check multiple crypto-currency transactions according to the authentication method described above in reference to FIG. 3; for instance the computing device 202 may perform the authentication process as described above in reference to FIG. 3 for a first set of one or more crypto-currency transactions, perform the authentication process a second time for a second set of one or more crypto-currency transactions, and combine the results to authenticate the first entity. The computing device 202 may compare the results of the first authentication to the results of the second authentication. The computing device 202 may authenticate the first entity only if the first and second authentication processes each authenticate the first entity.

In other embodiments, the computing device 202 requires the first entity to submit an additional item of secret information, such as a personal identification number (“PIN”), a password, or information unlikely to be known by another party. The supplemental source of authentication may be a hard token, and the additional secret information may be the output of the hard token. The supplemental source of authentication may be a soft token, and the additional secret information may be the output of the soft token.

The supplemental source of authentication may be biometric data; for instance, the first entity may be required to scan a fingerprint, thumbprint, or palm print as further authentication. The biometric sample may include hand geometry. The biometric sample may include a retinal scan. The biometric sample may include a digital photograph of a face. The biometric sample may include a sample of a voice. The biometric sample may include keystroke recognition. Where the first entity is a person, the biometric sample may be taken from the first entity directly. Where the first entity is an institution, firm or other non-personal entity, the biometric sample may be taken from a person that represents the first entity; for instance, the biometric sample may be taken from an executive or officer appointed to represent the first entity.

Although the foregoing systems and methods have been described in some detail for purposes of clarity of understanding, it will be apparent that certain changes and modifications may be practiced within the scope of the appended claims.

What is claimed is:

1. A method for crypto-currency transaction authentication, the method comprising:
receiving, by a computing device, from a data storage device associated with a first entity, authentication information demonstrating possession of a private key;
retrieving, by the computing device, from an audit chain, at least one crypto-currency transaction to an address associated with a public key corresponding to the private key;
authenticating, by the computing device, based on the retrieved crypto-currency transaction, the first entity.

2. A method according to claim 1, wherein receiving further comprises receiving the public key.

3. A method according to claim 1, wherein receiving further comprises receiving a digital signature signed with the private key.

4. A method according to claim 1, wherein receiving further comprises:
transmitting, by the computing device, a challenge datum to the data storage device; and
receiving a digital signature signing the challenge datum from the data storage device.

5. A method according to claim 1, wherein receiving further comprises:
transmitting, by the computing device, to the data storage device, a message encrypted using the public key; and
receiving, by the computing device, from the data storage device, a decrypted version of the message.

6. A method according to claim 1, wherein retrieving further comprises retrieving a transaction from a second entity to the first entity.

7. A method according to claim 6, wherein authenticating further comprises:
authenticating the second entity; and
determining that the at least one crypto-currency transaction represents an act of authentication of the first entity by the second entity.

8. The method of claim 6, wherein the transaction from the first second entity to the first entity further comprises a transaction granting access rights to the first entity.

9. A method according to claim 1, wherein authenticating further comprises determining a reputation based on the at least one crypto-currency transaction.

10. A method according to claim 1, wherein authenticating further comprises determining the commercial nature of the at least one crypto-currency transaction.

11. A method according to claim 1, wherein authenticating further comprises determining a financial value of the at least one crypto-currency transaction.

12. A method according to claim 1, wherein authenticating further comprises determining an identity of the first entity.

13. A method according to claim 1, wherein authenticating further comprises determining at least one access right of the first entity

14. A method according to claim 13, wherein determining the at least one access right further comprises:
determining that the second entity possesses at least one access right; and
determining that the at least one crypto-currency transaction represents a transfer of the at least one access right possessed by the second entity to the first entity.

15. A method according to claim 13, wherein determining the at least one access right further comprises:
identifying the first entity; and
retrieving an access right previously associated with the first entity.

16. The method of claim 1, wherein the audit chain comprises a secured audit chain.

17. The method of claim 1, wherein the audit chain comprises a cryptographically secured audit chain.

18. The method of claim 1, wherein the audit chain comprises a block chain.

19. The method of claim 1 further comprising filing, by the computing device, the at least one crypto-currency transaction.

20. A system for crypto-currency transaction authentication, the system comprising:
a data storage device associated with a first entity;
a computing device configured to receive, from the data storage device, authentication information demonstrating possession of a private key, to retrieve, from an audit chain, at least one crypto-currency transaction to an address associated with a public key corresponding to the private key, and to authenticate, based on the retrieved crypto-currency transaction, the first entity.
